(19) United States
(12) Patent Application Publication
(10) Pub. No.: US 2015/0268828 A1
(43) Pub. Date: Sep. 24, 2015

(54) INFORMATION PROCESSING DEVICE AND COMPUTER PROGRAM

(71) Applicant: Panasonic Intellectual Property Management Co., Ltd., Osaka (JP)

(72) Inventors: Tomoko KAJIMOTO, Osaka (JP); Hiroki ETOH, Osaka (JP); Ryota TSUKIDATE, Osaka (JP)

(21) Appl. No.: 14/658,550

(22) Filed: Mar. 16, 2015

(30) Foreign Application Priority Data
Mar. 18, 2014 (JP) 2014-054772

(51) Int. Cl. G06F 3/0484

(52) U.S. Cl. CPC G06F 3/04845; G06F 3/04847

(57) ABSTRACT

An information processing device according to an exemplary embodiment of the present invention includes a display device that displays an image, a user interface that receives a user operation, a detection circuit that detects the user operation to the user interface, and a processing circuit that causes the display device to display the image with a received display magnification when receiving a change operation of a display magnification of the image as the user operation, and causes the display device to display an image object in accordance with a drawing operation when receiving the drawing operation as the user operation. The processing circuit causes the display device to display the image object with a thickness or a size not depending on the display magnification while maintaining a relative positional relationship between the image and the image object.

### BACKGROUND

1. Field

The present disclosure relates to a user interface technique for input to an information processing device having an enlargement/reduction display function of an image.

2. Description of the Related Art

Unexamined Japanese Patent Publication No. S58-10260 has disclosed an electronic painting device. The electronic paining device has a light pen and a display device. The electronic painting device receives selection of a color and a line thickness of the light pen from a user. The user can draw a picture in color on a cathode-ray tube of the display device, using the light pen.

### SUMMARY

An information processing device according to an exemplary embodiment of the present invention includes a display device that displays an image, a user interface that receives an operation by a user, a detection circuit that detects the operation to the user interface by the user, and a processing circuit that causes the display device to display the image with a received display magnification when receiving a change operation of a display magnification of the image as the operation, and causes the display device to display an image object in accordance with a drawing operation when receiving the drawing operation as the operation. The processing circuit causes the display device to display the image object with a thickness or a size not depending on the display magnification while maintaining a relative positional relationship between the image and the image object.

### BRIEF DESCRIPTION OF DRAWINGS

FIG. 1 is a view showing a configuration of image processing system 100 according to the present disclosure;

FIG. 2 is a diagram showing a hardware configuration of tablet terminal 10a;

FIG. 3A is a view showing a display example of an image in tablet terminal 10a;

FIG. 3B is a view showing an enlargement display example of a picture shown in FIG. 3A;

FIG. 4 is a view showing an example of magnification adjustment panel 35;

FIG. 5 is a view showing a picture of Japanese map displayed in tablet terminal 10a, and magnification adjustment panel 35;

FIG. 6 is a view showing a display example when the Japanese map shown in FIG. 5 is enlarged by 300% by a change operation of display magnification by a user, using display magnification adjustment panel 35;

FIG. 7 is a view showing a writing example of image object 70 in a normal mode;

FIG. 8 is a view showing a writing example of image object 70 in an annotation mode;

FIG. 9 is a flowchart showing a procedure of writing processing in the annotation mode;

FIG. 10 is a view of a display example of icon 92 notifying existence of the image object;

FIG. 11 is a flowchart showing a procedure of display magnification change processing after writing in the annotation mode; and

FIG. 12 is a view showing an example of a plurality of icons 92 notifying existence of a plurality of image objects, and thumbnail image display area 93 where thumbnail images 93-1 to 93-4 of the respective image objects are displayed.

### DETAILED DESCRIPTION

Hereinafter, referring to the drawings as needed, an exemplary embodiment will be described in detail. However, unnecessary detailed description may be omitted. For example, detailed description of well-known items and redundant description of substantially the same configuration may be omitted. This is intended to avoid unnecessary redundancy and facilitate understanding of those in the art.

The present inventor(s) provides the accompanying drawings and the following description for those in the art to sufficiently understand the present disclosure, and these are not intended to limit the subject of claims.

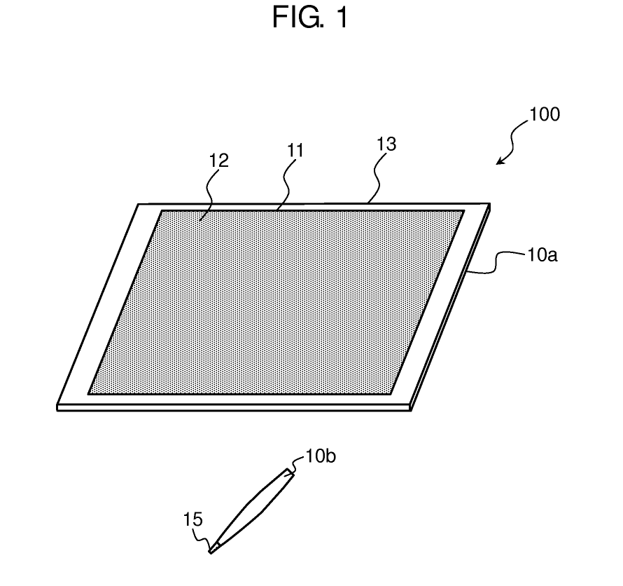

Hereinafter, referring to FIGS. 1 to 12, the exemplary embodiment of an information processing device according to the present disclosure will be described. In the present specification, the information processing device will be described as a tablet terminal.

### [1-1. Configuration]

FIG. 1 shows a configuration of information processing system 100 according to the present exemplary embodiment. Information processing system 100 includes tablet terminal 10a and stylus pen 10b. A user uses stylus pen 10b to perform a touch operation to tablet terminal 10a and operate tablet terminal 10a.

Tablet terminal 10a includes touch panel 11, display panel 12, and housing 13.

Touch panel 11 is a user interface that receives the touch operation by the user. Touch panel 11 is arranged so as to be superposed on display panel 12 and has an extent covering at least an operation area.

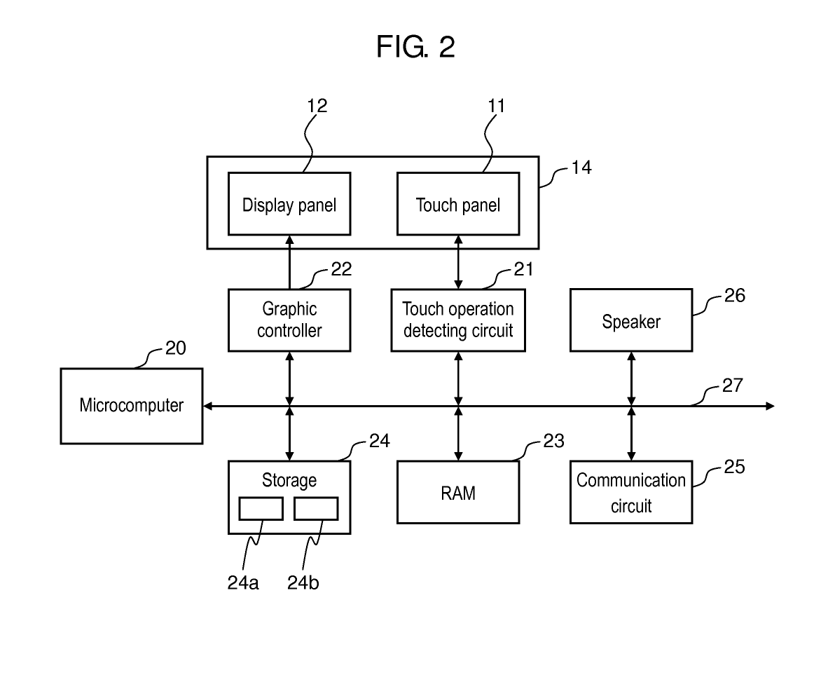

In the present exemplary embodiment, an example will be described in which the user performs the touch operation, using stylus pen 10b. While in the present exemplary embodiment, a description will be given on an assumption that touch panel 11 and display panel 12 are separate bodies, touch panel 11 and display panel 12 may be formed integrally. FIG. 2 described later shows touch screen panel 14 containing functions of touch panel 11 and of display panel 12. Touch screen panel 14 may have the configuration in which touch panel 11 and display panel 12 being separate bodies are superposed, or a so-called in-cell type configuration in which wiring for a touch sensor is provided in each cell in a structural component of the display panel.

Display panel 12 is a so-called display device. Display panel 12 displays an image, based on image data processed by graphic controller 22 described later. Display panel 12 can display text data such as characters, numerals and the like, and figures. In the present description, these may be comprehensively referred to as an “image object”. The image object may be a diagrammatic drawing that the user draws in handwriting, or may be a figure (including rectilinear and curvilinear diagrammatic drawings and the like) and an image that are prepared in advance.

In the present exemplary embodiment, display panel 12 is a 32-inch or 20-inch liquid crystal panel, and has a screen resolution of 3840×2560 dots.

As display panel 12, in addition to the liquid crystal panel, a publicly known display device such as, for example, an organic EL (Electroluminescent) panel, electronic paper, a plasma panel, and the like can be used. Display panel 12 may include a power supply circuit and a drive circuit, and may include a power source in some types of panels.

Housing 13 contains touch panel 11 and display panel 12. In housing 13, a power button, a speaker and the like may be further provided, but are not described in FIG. 1.

Stylus pen 10b is one type of a pointing device. The user brings tip portion 15 of stylus pen 10b into contact with touch panel 11 to thereby perform a touch operation. Tip portion 15 of stylus pen 10b is formed of a material adapted for a touch operation detecting system in touch panel 11 of tablet terminal 10a. In the present exemplary embodiment, since touch panel 11 detects the touch operation by a capacitive system, tip portion 15 of stylus pen 10b is formed of conductive metal fibers, conductive silicone rubber or the like.

FIG. 2 shows a hardware configuration of tablet terminal 10a.

Tablet terminal 10a includes touch panel 11, display panel 12, microcomputer 20, touch operation detecting circuit 21, graphic controller 22, RAM (Random Access Memory) 23, storage 24, communication circuit 25, speaker 26, and bus 27.

Touch panel 11 and touch operation detecting circuit (hereinafter, referred to as a “detection circuit”) 21 detect the touch operation of the user, for example, by a projected capacitive system.

Touch panel 11 is configured of, in order from a side of user's operation, an insulator film layer such as glass and plastic, an electrode layer, and a substrate layer with detection circuit 21 that performs arithmetic processing. The electrode layer has transparent electrodes arranged in matrix on an X axis (e.g., a horizontal axis) and on a Y axis (e.g., a vertical axis). The respective electrodes may be arranged at a density smaller than respective pixels of display panel 12, or may be arranged at a density almost equivalent to that of the respective pixels. A description will be given on an assumption that the present exemplary embodiment employs the former configuration.

As touch panel 11, for example, an electrostatic type, a resistance film type, an optical type, an ultrasonic type, an electromagnetic type of touch panels and the like can be used.

Detection circuit 21 sequentially scans the matrix of the X axis and the Y axis. When a change in capacitance is detected, detection circuit 21 detects that the touch operation has been performed at a relevant position, and generates coordinate information at a density (resolution) equivalent to, or higher than densities (resolution) of the respective pixels of display panel 12. Detection circuit 21 can simultaneously detect the touch operations at a plurality of positions. Detection circuit 21 continuously outputs a series of coordinate data detected due to the touch operations. This coordinate data is received by microcomputer 20 described later, and is detected as various types of touch operations (tap, drag, flick, swipe and the like). A function of detecting the above-described touch operations is typically implemented as a function of an operating system that operates tablet terminal 10a.

Microcomputer 20 is a processing circuit (e.g., a CPU (central processing unit)) that performs various types of processing described later using information of a touch position by the user, the information received from detection circuit 21.

Graphic controller 22 operates based on a control signal generated by microcomputer 20. Graphic controller 22 generates image data to be displayed on display panel 12, and controls display operation of display panel 12.

RAM 23 is a so-called work memory. In RAM 23, a computer program is decompressed that is for operating tablet terminal 10a, the computer program executed by microcomputer 20.

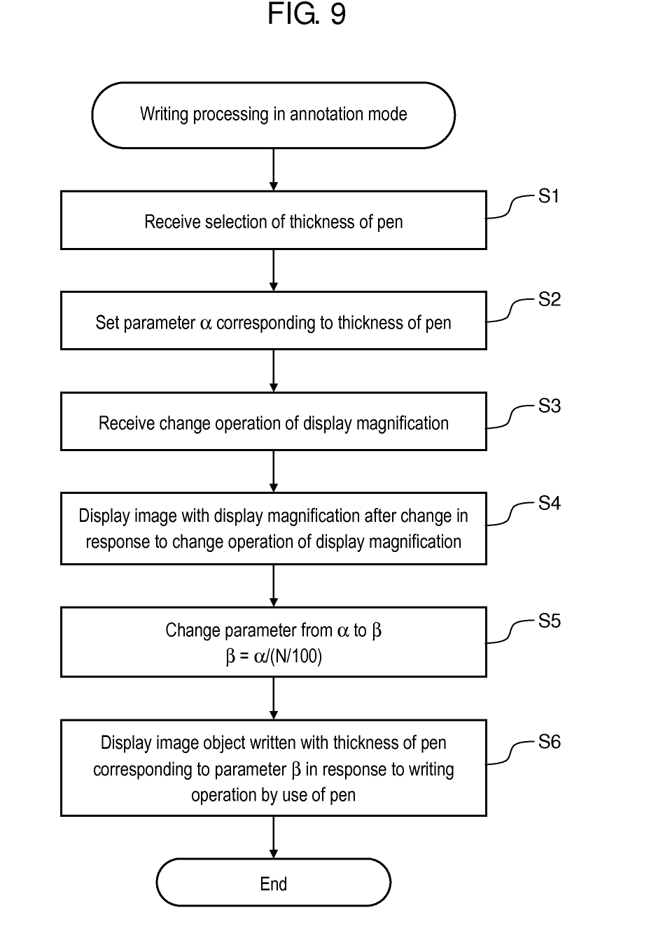

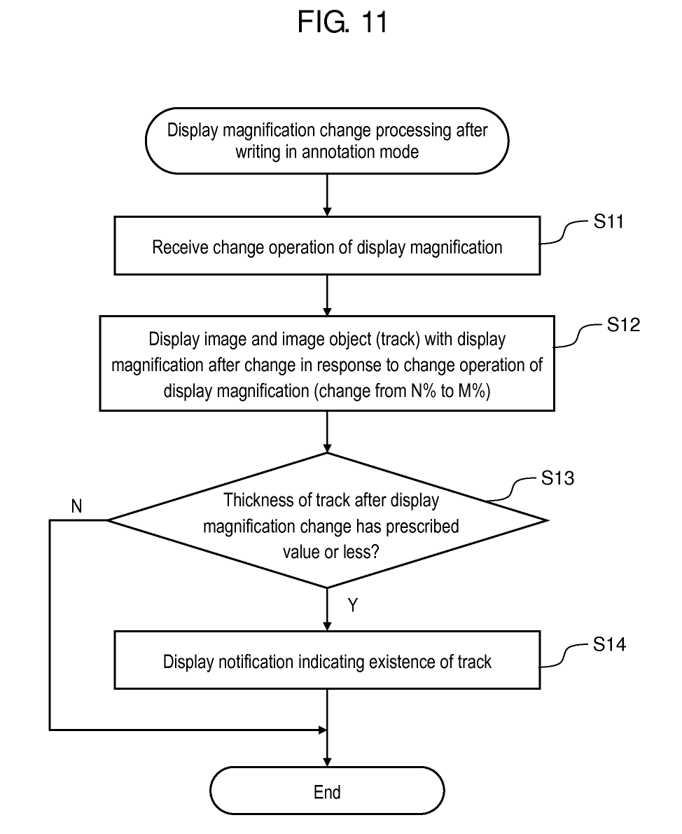

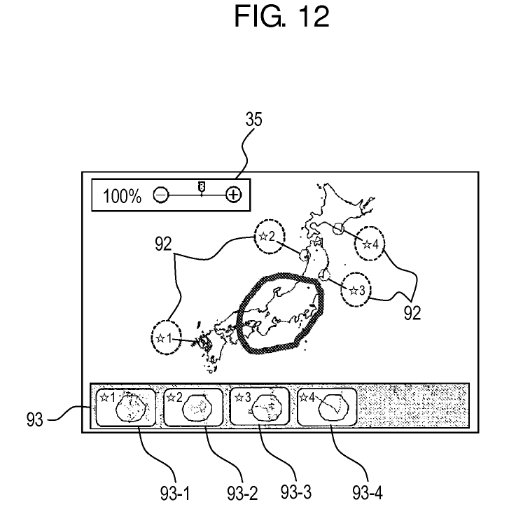

In this computer program, for example, procedures of processing corresponding to FIGS. 9 and 11 described later are described. However, even processing that is described in the present specification but is not illustrated can be prescribed as the processing by the computer program.

Storage 24 is, for example, a flash memory. Storage 24 stores image data 24a used for display and above-described computer program 24b. In the present exemplary embodiment, image data 24a includes data of a still picture such as a design drawing, and three-dimensional moving image data to enable a virtual tour of an architectural structure described later.

Communication circuit 25 is a circuit that enables, for example, communication with the Internet, a personal computer, and the like. Communication circuit 25 is a wireless communication circuit conformable to, for example, a Wi-Fi standard, and/or a Bluetooth (registered trademark) standard.

Speaker 26 outputs audio based on an audio signal generated by microcomputer 20.

Bus 27 is a signal line that mutually connects the above-described components except for touch panel 11 and display panel 12 to enable transmission and reception of signals.

As described above, in the present disclosure, an example will be described in which the user performs the touch operation, using stylus pen 10b. However, the touch operation by use of stylus pen 10b is not essential. Means for the touch operation is not limited, as long as operations described later, specifically, a change operation of a display magnification of the image displayed on display panel 12, and a display operation of the image object on display panel 12 can be performed. For example, the user may perform the operation using a finger of his or her own, or may perform the operation using a mouse as a pointing device. In the former example, touch panel 11 functions as a user interface for detecting contact of the finger of the user. In the latter example, a terminal connected to the mouse and/or a circuit that interprets a signal input to the relevant terminal function(s) as the user interface.

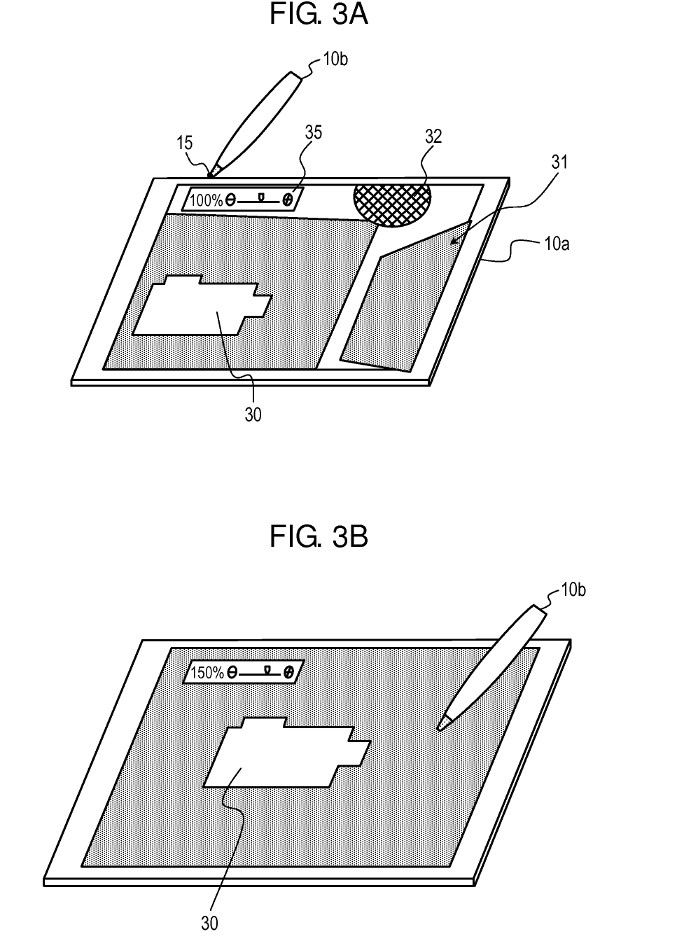

FIG. 3A shows a display example of an image in tablet terminal 10a. FIG. 3A shows the display example of the image regarding a map. The displayed image includes various image objects. For example, the example of FIG. 3A shows image object 30 of a plan view of an architectural structure, image object 31 regarding a sectioned site, and installed object 32 on a road.

Furthermore, FIG. 3A shows magnification adjustment panel 35. The user touches magnification adjustment panel 35 with tip portion 15 of stylus pen 10b to adjust the display magnification. This can enlarge or reduce the displayed image.

The “image object” in the present specification means an element configuring an image to be displayed as so-called content. The image object does not include magnification adjustment panel 35 which does not configure the content. However, even an element generally considered to fall under the content may not be included in the image object of the present disclosure. As described later, in the present disclosure, enlargement or reduction is performed in a state where a relative positional relationship is held between the image and image object. At this time, a display element that is not an object of the enlargement or the reduction (a thumbnail image or the like simply superposed) does not fall under the “image object” in the present disclosure. In the present disclosure, for example, an element written by the user may be included in the image object. It is because the foregoing element is enlarged or reduced in the state where the relative positional relationship is held between the image and the image object.

Moreover, in the present specification, “enlargement” of an image means that the image is expanded and displayed larger, and “reduction” of an image means that the image is contracted and made smaller. Specific means for implementing the enlargement and the reduction is not limited, as long as the image is displayed larger or smaller for the user. For example, when a vector graphics format image is prepared and a magnification is selected by the user, microcomputer 20 or graphic controller 22 may perform calculation to change the image into, and display an image of a resolution corresponding to the selected magnification. Alternately, an image made up of a plurality of partial images (tile images) may be prepared based on magnifications set discretely. When an image directly corresponding to the selected magnification is not prepared, microcomputer 20 or graphic controller 22 performs image complementary processing, using the tile images of the magnifications one scale above and below the selected magnification to generate the image corresponding to the selected magnification. The image may be enlarged or reduced using other methods.

FIG. 3B shows an enlarged display example of a picture shown in FIG. 3A. If the display magnification in FIG. 3A is 100% (unmagnification), the display magnification set in the example in FIG. 3B is 150%. As a result, FIG. 3B shows only image object 30 of the plan view of the architectural structure.

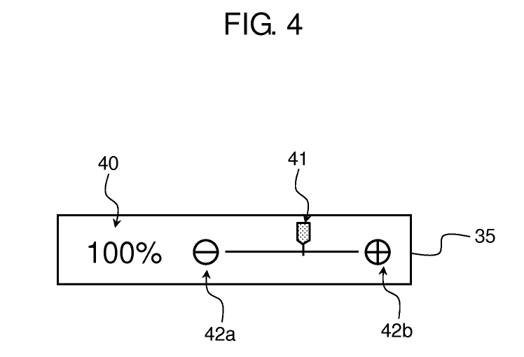

FIG. 4 shows an example of magnification adjustment panel 35. Magnification adjustment panel 35 has display magnification designating field 40, slider 41, reduction button 42a, and enlargement button 42b. The user contacts any one of these with tip portion 15 of stylus pen 10b to adjust the enlargement/reduction magnification. A description is given on an assumption that a median value of slider 41 corresponds to an enlargement ratio 100%.

### [1-2. Operation]

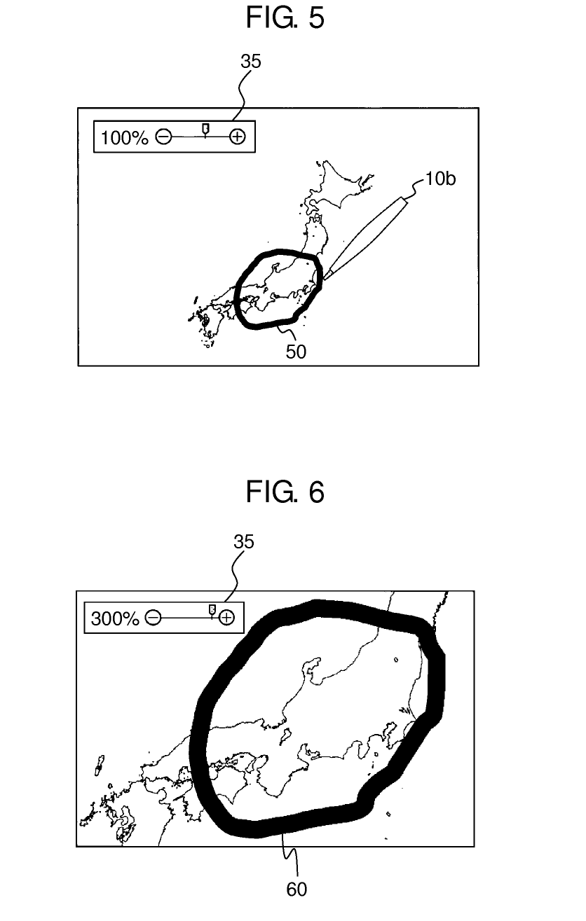

Next, referring to FIGS. 5 to 12, operation of tablet terminal 10a will be described.

### 1. Writing Processing

FIG. 5 shows a picture of a Japanese map displayed on tablet terminal 10a, and magnification adjustment panel 35. The magnification is 100% (unmagnification), and it is assumed that a line thickness is set to 5 points based on designation by the user. When the user draws a line around part of the Japanese map using stylus pen 10b, microcomputer 20 instructs graphic controller 22 to draw track 50 of the user's drawing on display panel 12 with the set thickness of 5 points.

Next, an example will be considered in which the user enlarges the Japanese map in order to specify still another position and continues the drawing.

FIG. 6 shows a display example when the Japanese map shown in FIG. 5 is enlarged by 300% by the change operation of the display magnification by the user, using display magnification adjustment panel 35. Microcomputer 20 instructs graphic controller 22 to enlarge not only the Japanese map but track 50 displayed in FIG. 5 with the same magnification. FIG. 6 shows enlarged track 60. Since original track 50 is drawn with the thickness of 5 points, track 60 is displayed with a thickness equivalent to 15 points.

Next, an example will be considered in which the user performs writing indicating still another position in the Japanese map displayed in FIG. 6. Tablet terminal 10a according to the present disclosure has at least two modes regarding writing processing. That is, the modes are a “normal mode” and an “annotation mode”. In tablet terminal 10a, microcomputer 20 may operate by optionally switching between the “normal mode” and the “annotation mode” in accordance with selection of the user or with the processing of the terminal. Tablet terminal 10a may include only the “annotation mode”.

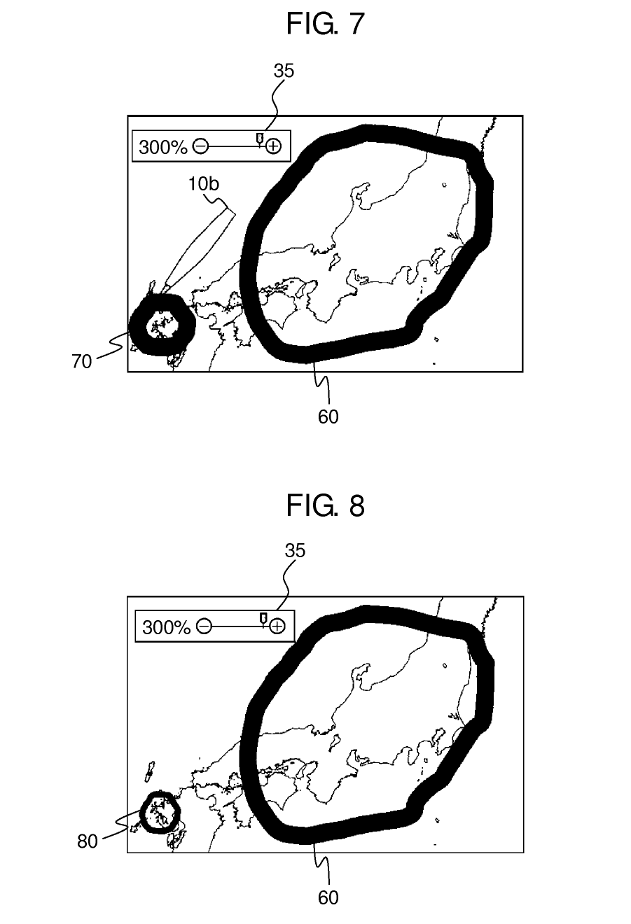

In the following, the normal mode will be described with reference to FIG. 7. The annotation mode will be described with reference to FIGS. 8 and 9.

### 1. 1. Wiring Processing in Normal Mode

FIG. 7 shows a writing example of image object 70 in the normal mode. An operation will be considered in which the user draws a line around part of Kyushu Region (e.g., Shimabara Peninsula) on a left side of the drawing, using stylus pen 10b. Microcomputer 20 receives the drawing operation and instructs graphic controller 22 to cause display device 12 to display track 70 corresponding to the operation.

It should be noted that writing in the picture enlarged by 300% allows track 70 to be displayed with the thickness equivalent to the thickness of track 60, that is, equivalent to 15 points. While it can be said that visibility is increased, it is considered to be relatively difficult to perform fine work of drawing a line around a partial region. When it is desired to perform delicate work, the writing processing in the annotation mode is useful.

### 1. 2. Writing Processing in Annotation Mode

FIG. 8 shows a writing example of image object 70 in the annotation mode. In the annotation mode, microcomputer 20 displays the image object on display panel 12 with a thickness or a size not depending on the display magnification. For example, in the present exemplary embodiment, microcomputer 20 causes track 80 as the image object to be displayed on display panel 12 with the thickness equivalent to 5 points, which is the thickness of the pen in the magnification before the enlargement (the enlargement ratio 100%). It can be understood that the thickness of track 80 shown in FIG. 8 is the same as the thickness of track 50 shown in FIG. 5. Since track 80 is thinner than track 70 in FIG. 7, it can be said that the annotation mode is a very useful writing mode when more delicate writing work needs to be performed.

FIG. 9 is a flowchart showing a procedure of the writing processing in the annotation mode.

In step S1, microcomputer 20 receives selection of the thickness of a drawing pen from the user. The drawing pen is a virtual pen displayed on display panel 12 when the writing by use of stylus pen 10b is performed. Typically, a cursor or a mark is displayed on display panel 12 while reflecting the thickness of the drawing pen, and a color and a line type at the time of drawing. While a physical thinness of a tip of stylus pen 10b is invariable, the user selects the drawing pen having various thicknesses, colors, line types to operate the drawing pen using stylus pen 10b, which enables drawing with a high degree of freedom. Since stylus pen 10b and the drawing pen have a corresponding relationship, it is considered that intention and an object are obvious even if the terms are not particularly distinguished. Consequently, hereinafter, stylus pen 10b and the drawing pen are simply described as a “pen”.

In step S2, microcomputer 20 sets parameter α corresponding to the thickness of the pen. For example, when the user designates 5 points as the thickness of the pen, parameter α=5 may be set.

In step S3, microcomputer 20 receives a display magnification change operation by the user. For example, the user uses display magnification adjustment panel 35 to change the display magnification of 100% to N %.

In step S4, in response to the change operation of the display magnification by the user, microcomputer 20 instructs graphic controller 22 to display the image with the display magnification after the change. Upon receiving the instruction, graphic controller 22 displays an image enlarged N/100 times on display panel 12.

In step S5, microcomputer 20 changes the parameter from α to β. Here, β is a value obtained from β=α/(N/100). This processing corresponds to processing of magnifying the line thickness 1/(N/100) times on the image enlarged N/100 times. This processing enables the line to be drawn on the image enlarged N/100 times with absolutely the same thickness as the thickness of the pen before the display magnification change.

In step S6, microcomputer 20 sends an instruction to graphic controller 22 in response to the writing operation by use of the pen. Graphic controller 22 displays the image object, a result of the writing, with the thickness of the pen corresponding to parameter β on the image of the display magnification N %. As a result, track 80 shown in FIG. 8 is drawn.

While in the above-described example, parameter β is used that cancels off the change of the display magnification so that the thickness of the pen is equalized before and after the display magnification change, this method is one example. For example, a layer that display the image and a layer that display image object are made different, and as to the layer that displays the image object, the resolution is made constant before and after the display magnification change without changing. This method can realize the thickness or the size of the diagrammatic drawing of the image object that does not depend on the change in the display magnification of the image.

As described above, according to the writing processing in the annotation mode, the thickness or the size of the diagrammatic drawing can be made constant to draw the image object without depending on the display magnification after the change.

2. Display Magnification Change Processing after Writing

Next, an operation will be described that is performed when the display magnification is changed after the image object is written.

When the image object (track 70 in FIG. 7) is written in the normal mode and subsequently the display magnification change processing is performed, the image object only needs to be enlarged or reduced with the same magnification as that of the image. The processing of changing the image and the image object with the same display magnification is very obvious, and thus, a description using a flowchart will be omitted.

Next, the display magnification change processing will be described that is performed after writing in the annotation mode.

An example will be considered in which after the image object (track 80 in FIG. 8) is written in the annotation mode, the display magnification is, for example, reduced from 300% to 100%. As in the normal mode, when the image and the image object are reduced, track 80 thinner than track 70 (FIG. 7) becomes very thin due to the reduction. In some reduction ratios, there is a possibility that visual recognition is difficult.

Consequently, in the present disclosure, a notification is given regarding existence of the image object having a prescribed thinness or less, or a prescribed size or smaller because of the reduction processing.

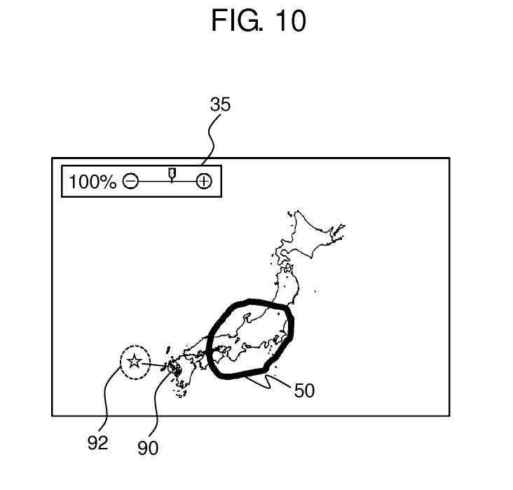

FIG. 10 shows a display example of icon 92 notifying existence of the image object. Track 90 is the image object corresponding to track 80 in FIG. 8, and is reduced by the display magnification change processing so thin that the visual recognition is difficult. In the present disclosure, icon 92 is displayed that notifies the existence of the image object (track 90). Only icon 92 may be displayed in the vicinity of the image object, or as shown in FIG. 10, a leader line may be added to icon 92. The notification enables the user to more precisely determine at which position the image object exists.

FIG. 11 is a flowchart showing a procedure of the display magnification change processing after the writing in the annotation mode.

In step S11, microcomputer 20 receives the display magnification change operation by the user. For example, the user changes the display magnification from N % to M %, using display magnification adjustment panel 35. Here, N>M is assumed.

In step S12, microcomputer 20 sends an instruction to graphic controller 22 in response to the change operation of the display magnification. Graphic controller 22 displays the image and the image object (the track) with the display magnification after the change. In this example, the display magnification is changed from N % to M %.

In step S13, microcomputer 20 determines whether or not the thickness of the track after the display magnification change has a prescribed value or less. If the thickness has the prescribed value or less, the processing advances to step S14, and otherwise, the processing ends. The prescribed value may be decided in accordance with a resolution of human visual sense. In this case, a relationship between the resolution of human eyes and the resolution of display panel 12 is preferably considered as well.

Alternatively, the prescribed value may be dynamically decided in view of a relationship between a background color and a color of the image object. For example, if the background color and the color of the image object have a complementary color relationship, a value smaller than a reference value T (T−k) may be set as the prescribed value. On the other hand, if the background color and the color of the image object do not have the complementary color relationship, a value larger than the reference value T (T+k) may be set as the prescribed value.

In step S14, microcomputer 20 sends an instruction to graphic controller 22 to display icon 92 as a notification indicating the existence of the track, and the processing ends.

While in the above-described example, the description is given on the assumption that icon 92 is displayed on display panel 12 as the notification, this is only one example. Various ways can be considered for the notification that allows the user to recognize the existence of the image object. For example, an area in a prescribed range including track 90 may be inverted and blinked. Alternately, when stylus pen 10b or a finger comes into contact with an area where track 90 exists, housing 13 may be vibrated, and a light-emitting portion (not shown) provided on housing 13 may be caused to emit light, or sound may be output from speaker 26 (FIG. 2). The notification may be presented, using at least one of vibration, light, and sound.

### [1-3. Effects and the Like]

As described above, tablet terminal 10a according to the present exemplary embodiment includes display panel 12 that displays an image, touch panel 11 that receives an operation by the user, touch operation detecting circuit 21 that detects the operation to touch panel 11 by the user, and microcomputer 20 that causes display panel 12 to display the image with a received display magnification when receiving a change operation of a display magnification of the image as the operation, and causes display panel 12 to display an image object in accordance with a drawing operation when receiving the drawing operation as the operation. Microcomputer 20 causes the image object to be displayed on display panel 12 with a thickness or a size not depending on the display magnification.

For example, even when the image object is added after the image is enlarged and displayed, the image object is not displayed large by being affected by the enlargement ratio. This eliminates a situation in which the image object is displayed too large, so that writing is difficult or impossible. The present disclosure is preferable under a use environment where delicate work needs to be performed after enlargement. For example, in a use in which an art work is photographed with a super high resolution to check a damaged portion of the work using the image, after the image is enlarged very large, it is necessary to mark the minute damaged portion on the image. In this case, since the mark does not become too large, delicate check work of the damaged portion can be efficiently conducted. As another example, the present disclosure may be preferably used in a medical field. In a use in which an organ or the like of a patient is photographed with a super high resolution to check a tumor or a diseased part later using the image, after the image is substantially enlarged, it is necessary to mark the minute diseased part on the image. In this case as well, as with the example of the art work, the delicate check work of the diseased part or the like can be efficiently performed.

While in the foregoing description, the handwritten diagrammatic drawing is the image object, this is one example. The image object may not be the handwritten diagrammatic drawing. For example, a prescribed figure may be written like a stamp at a position that tip portion 15 touches.

Moreover, as to the above-described display magnification change processing (typically, the reduction processing) after writing, another modification can be considered. For example, in addition to the notification by the icon, a thumbnail image of a relevant portion may be displayed. FIG. 12 shows an example of a plurality of icons 92 notifying the existence of a plurality of image objects, and thumbnail image display area 93 where thumbnail images 93-1 to 93-4 of the respective image objects are displayed. When the plurality of image objects exist, each icon 92 includes a mark and a numeral. Thumbnail image display area 93 displays thumbnail images 93-1 to 93-4, based on respective pairs of the mark and the numeral. Thumbnails images 93-1 to 93-4 are each displayed with a magnification adjusted so that a track of a line (the image object) written by the user is contained in the display area.

When the user selects any of icons 92 with stylus pen 10b, microcomputer 20 sends an instruction to graphic controller 22 in response to the selection operation, and for example, causes a frame of the thumbnail image corresponding to selected icon 92 to be highlighted or displayed relatively thicker. On the other hand, when the user selects any of the thumbnail images with stylus pen 10b, in response to the selection operation, microcomputer 20 sends an instruction to graphic controller 22 to, for example, cause the icon indicating the pair of the mark and the numeral corresponding to the relevant thumbnail image to be blinked or highlighted. That is, when receiving the operation to select one of the icon and the thumb nail image as the touch operation by the user, microcomputer 20 sends the instruction to graphic controller 22 to display the other of the icon and the thumbnail image so as to be visually recognizable.

According to the above-described processing, even when the image object is reduced by the display magnification change processing so thin that the visual recognition is difficult, the user can easily recognize an existing position of the image object or details of the image object. In order to enhance the visibility, for example, a line connecting the icon and the thumbnail may be displayed.

As another example, a method may be employed in which the reduction processing is performed without the notification. Alternatively, the processing may be performed so that the line thickness and the size of the image object are not changed before and after the display magnification change processing after writing.

As described above, as illustration of the technique in the present disclosure, the exemplary embodiment has been described. For this, the accompanying drawings and detailed description have been presented.

Accordingly, for the illustration of the above-described technique, the components described in the accompanying drawings and the detailed description may include not only the components essential for solving the problems but the components inessential for solving the problems. Thus, the inessential components should not be recognized to be essential because the inessential components are described in the accompanying drawings and the detailed description.

Moreover, the above-described exemplary embodiment is to illustrate the technique in the present disclosure, and thus, various modifications, replacements, addition, omission and the like can be made in the scope of the claims and in an equivalent scope thereof.

The exemplary embodiment of the present invention can be applied to a device having an editing function of a picture and an enlargement/reduction display function of a picture. Specifically, the present disclosure can be applied to a tablet computer, a PC (personal computer), a portable telephone, a smartphone or the like. Moreover, the present disclosure can be applied to a computer program to enable editing of a picture and enlargement/reduction display of a picture.

What is claimed is:

1. An information processing device comprising:
a display device that displays an image;
a user interface that receives an operation by a user;
a detection circuit that detects the operation to the user interface by the user; and
a processing circuit that causes the display device to display the image with a received display magnification when receiving a change operation of a display magnification of the image as the operation, and causes the display device to display an image object in accordance with a drawing operation when receiving the drawing operation as the operation,
wherein the processing circuit causes the display device to display the image object with a thickness or a size not depending on the display magnification while maintaining a relative positional relationship between the image and the image object.

2. The information processing device according to claim 1,
wherein when the drawing operation is an operation regarding drawing of a diagrammatic drawing,
the processing circuit causes the display device to display the image object of the diagrammatic drawing with a thickness not depending on the display magnification.

3. The information processing device according to claim 1,
wherein when the drawing operation is an operation regarding drawing of a figure,
the processing circuit causes the display device to display the image object of the figure with a size not depending on the display magnification.

4. The information processing device according to claim 1,
wherein when the change operation of the display magnification of the image is received, and when a parameter α corresponding to a thickness or a size in the display magnification before the change operation is performed is preset, and yet when the display magnification after the change operation is performed referencing the display magnification before the change operation is N times,
the processing circuit causes the display device to display the image object with a thickness or a size corresponding to a parameter β defined by β=α/N on the image displayed with the received display magnification.

5. The information processing device according to claim 1,
wherein after the display device is caused to display the image object with a thickness or a size not depending on the display magnification and the change operation of the display magnification is subsequently received,
in response to the change operation of the display magnification, the processing circuit causes the display device to display the image object with a thickness or a size depending on the display magnification while maintaining a relative positional relationship between the image and the image object, and when the thickness or the size of the image object has a predetermined value or less, the processing circuit outputs a notification indicating existence of the image object.

6. The information processing device according to claim 5,
wherein the notification is displayed in a vicinity of a position where the image object exists.

7. The information processing device according to claim 5,
wherein the notification is displayed in a manner as to indicate a position where the image object exists.

8. The information processing device according to claim 5,
wherein the notification includes at least one of vibration, light, and sound.

9. The information processing device according to claim 5,
wherein when the thickness or the size of the image object has the predetermined value or less, the processing circuit causes the display device to display a thumbnail image regarding the image object with a predetermined magnification in a superposed manner.

10. The information processing device according to claim 9,
wherein when receiving an operation by the user of selecting one of the notification and the thumbnail image as the operation to the user interface, the processing circuit displays a remaining one of the notification and the thumbnail image identifiably.

11. The information processing device according to claim 1,
wherein the processing circuit displays the image object written by the drawing operation by the user on the display device.

12. A computer program executed by a processing circuit of an information processing device,
the information processing device comprising a display device that displays an image, a user interface, a detection circuit that detects an operation to the user interface by a user, and a processing circuit,
wherein the computer program causes the processing circuit:
to receive the operation by the user through the user interface;
to cause the display device to display the image with a received display magnification when a change operation of a display magnification of the image is received as the operation; and
to cause the display device to display an image object in accordance with a drawing operation with a thickness or a size not depending on the display magnification while maintaining a relative positional relationship between the image and the image object, when the drawing operation is received as the operation.
